(19) United States
(12) Patent Application Publication
(10) Pub. No.: US 2019/0393664 A1
(43) Pub. Date: Dec. 26, 2019

(54) MANUFACTURING METHOD OF ELECTRIC WIRE BUNDLE, AND MANUFACTURING APPARATUS OF ELECTRIC WIRE BUNDLE

(71) Applicant: Yazaki Corporation, Tokyo (JP)

(72) Inventors: Sanae Katou, Makinohara-shi (JP); Shinya Warashina, Makinohara-shi (JP); Keita Takahashi, Makinohara-shi (JP)

(73) Assignee: Yazaki Corporation, Tokyo (JP)

(21) Appl. No.: 16/421,695

(22) Filed: May 24, 2019

(30) Foreign Application Priority Data
Jun. 25, 2018 (JP) 2018-119864

(51) Int. Cl. H01R 43/02; B23K 20/10; B23K 20/00; B23K 37/04

(52) U.S. Cl. CPC H01R 43/0207; H01R 43/0214; H01R 43/0263; B23K 2101/32; B23K 20/004; B23K 37/0426; B23K 20/106

(57) ABSTRACT

A manufacturing method of an electric wire bundle includes arranging a conductor core wire of a first electric wire at a processing position of a welding machine, arranging a second electric wire at the processing position so as to align an end position of a conductor core wire of the second electric wire with an end position of the conductor core wire of the first electric wire, forming a welding process to the conductor core wire of the first electric wire and the conductor core wire of the second electric wire by the welding machine to form a preliminary welding portion, forming the core wire welding portion by repeating processes for all of the plurality of electric wires, and controlling a magnitude of an energy used in the welding process based on characteristics of conductor core wires to be welded by the welding machine.

### CROSS-REFERENCE TO RELATED APPLICATIONS

This application is based on and claims priority under 35 USC 119 from Japanese Patent Application No. 2018-119864 filed on Jun. 25, 2018, the contents of which are incorporated herein by reference.

### TECHNICAL FIELD

The present disclosure relates to a manufacturing method of an electric wire bundle including a core wire welding portion in which a plurality of conductor core wires exposed from ends of a plurality of electric wires are welded to each other, and a manufacturing apparatus of the electric wire bundle.

### BACKGROUND ART

In a related art, as a method of connecting a plurality of electric wires without using a connection component such as a connector, Reference document 1 and Reference document 2 disclose a method of directly joining a plurality of conductor core wires exposed from terminals of a plurality of electric wires to form a core wire joint portion (so-called splice portion).

Specifically, in one related manufacturing method of an electric wire bundle, Reference Document 1 discloses that a plurality of conductor core wires are collectively set in a welding machine that is configured to weld the conductor core wires, and the conductor core wires are welded by applying the an ultrasonic welding treatment and a resistance welding treatment collectively to the conductor core wires.

Reference Document 1: JP H08-31469 A

Reference Document 2: JP 2016-185009 A

In the related manufacturing method of an electric wire bundle, when a plurality of conductor core wires are collectively set in the welding machine, a plurality of electric wires are gripped in a bundled state with a hand of an operator or a dedicated jig or the like. However, when gripping the plurality of electric wires in the bundled state, the hand of the operator or the jig or the like is in direct contact with the electric wires exposed on an outer periphery of a bundle of the electric wires (electric wire bundle), so that a position of the electric wire bundle in an axial direction is held. That is, it is possible to reduce or prevent positional deviations of the electric wires. Meanwhile, the hand of the operator or the like is not in contact with electric wires that are not exposed on the outer periphery of the electric wire bundle. Therefore, positions of the electric wires in the axial direction, not exposed on the outer periphery of the electric wire bundle, are held by frictional force between the adjacent electric wires or the like.

However, holding force applied to the latter electric wires (i.e., unexposed electric wires) depends on a number of electric wires included in the electric wire bundle, thicknesses of the electric wires, how to bundle the electric wires, or the like, so that it is not necessarily guaranteed whether sufficient holding force is applied to all of the electric wires. As a result, the positional deviations of the latter electric wires (i.e., unexposed electric wires) may occur. In particular, when the plurality of electric wires having different thicknesses are bundled together, the thin electric wire may be inserted in a free state into a gap formed between the thick electric wires, so that gripping force may not be substantially applied to the thin electric wire. That is, the positional deviations of the electric wire, to which the gripping force is not sufficiently applied, are likely to occur.

When the positional deviations of the electric wires included in the electric wire bundle occurs, a position of the conductor core wire exposed from an end of the electric wire also deviates. As a result, when the welding is performed in a state where positions of ends of the plurality of conductor core wires are not aligned, lengths of welded portions varies for each conductor core wire, so that sufficiently strong welding may not be performed. Therefore, in order to avoid the positional deviations, it is conceivable that the operator performs an operation such as aligning the positions of the ends of the conductor core wires. However, in this case, it is difficult to improve productivity due to the operation.

The present disclosure is provided in view of the above circumstances, and an object of the present disclosure is to provide a manufacturing method of an electric wire bundle, and a manufacturing apparatus of the electric wire bundle capable of forming a core wire welding portion while reducing or preventing a positional deviation of an electric wire.

### SUMMARY OF INVENTION

Aspect of non-limiting embodiments of the present disclosure relates to the manufacturing method of an electric wire bundle having a certain feature. After welding the conductor core wires of the two electric wires (the first electric wire and the second electric wire) among the plurality of electric wires to form the preliminary welding portion, the other electric wires are repeatedly welded to the preliminary welding portion one by one to form the core wire welding portion. In this manufacturing method, an end positions of the conductor core wires can be positively aligned each time the conductor core wires are welded one by one, so that an unintended positional deviation as the related manufacturing method described above can be reduced or prevented. Therefore, the core wire welding portion can be formed while reducing or preventing the positional deviation of the electric wires. Further, a welding state can be managed for each individual conductor core wire by controlling the energy for welding in the welding machine, based on the characteristics (for example, the thickness and the number of the strands, and the material of the strands) of the conductor core wire to be welded. As a result, as compared with a case where a large number of conductor core wires are welded at one time as in the related manufacturing method, it is possible to ensure reliable welding as a whole of the core wire welding portion.

Aspect of non-limiting embodiments of the present disclosure relates to the manufacturing method of an electric wire bundle having a certain feature. It is possible to reduce or prevent the welding process from being performed with excessive or insufficient energy, and to perform the welding process with appropriate energy depending on the conductor core wire to be welded, by performing the welding process with energy in consideration of the thickness and the number of the strands included in the conductor core wire. As a result, it is possible to ensure more reliable welding as a whole of the core wire welding portion.

Aspect of non-limiting embodiments of the present disclosure relates to the manufacturing method of an electric wire bundle having an certain feature. In the final welding process, energy larger than that used in the previous welding process is used such that the core wire welding portion as a final product has a size and a shape and the like as designed. As a result, the electric wire bundle excellent in quality such as dimensional accuracy of the core wire welding portion can be obtained.

Aspect of non-limiting embodiments of the present disclosure relates to the manufacturing method of an electric wire bundle having a certain feature. A magnitude of the energy for welding is larger than that used in previous welding process as the number of times of a plurality of welding processes (that is, the first, the second, the third, and the Nth welding process, and the Nth welding process is a final welding process) increases. Thereby, a total energy variation for each of the conductor core wires can be reduced as the conductor core wire welded at a stage of the welding process close to the first welding process among the plurality of welding processes, although the conductor core wire is also subjected to subsequent multiple welding processes (that is, total energy applied to the conductor core wire increases), as compared with a case where the magnitude of the energy is uniform regardless of the number of times of the welding processes. Thereby, it is possible to ensure reliable welding as a whole of the core wire welding portion, and to further reduce or prevent occurrence of breakage, and the like, in the conductor core wire due to excessive total energy of some of the conductor core wires.

Aspect of non-limiting embodiments of the present disclosure relates to the manufacturing method of an electric wire bundle having a certain feature. An ultrasonic welding process or a resistance welding process which is generally used can be applied to the manufacturing method according to the present disclosure. Further, a degree of welding of the conductor core wires can be controlled by adjusting the magnitude of the energy applied to the conductor core wires when the processes are performed.

Aspect of non-limiting embodiments of the present disclosure relates to the manufacturing apparatus of an electric wire bundle having a certain feature. After welding the conductor core wires of the two electric wires (the first electric wire and the second electric wire) among the plurality of electric wires to form the preliminary welding portion, the other electric wires are repeatedly welded to the preliminary welding portion one by one to form the core wire welding portion, by the arrangement mechanism and the welding machine. At this time, an end positions of the conductor core wires can be positively aligned each time the conductor core wires are welded one by one, so that an unintended positional deviation as the related manufacturing method described above can be reduced or prevented. Therefore, the core wire welding portion can be formed while reducing or preventing the positional deviation of the electric wires. Further, a welding state can be managed for each individual conductor core line by controlling the energy for welding in the welding machine based on the characteristics (for example, the thickness and the number of the strands, and the material of the strands) of the conductor core wire to be welded. As a result, as compared with a case where a large number of conductor core wires are welded at one time as in the related manufacturing method, it is possible to ensure reliable welding as a whole of the core wire welding portion.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an manufacturing method of an electric wire bundle including: arranging a conductor core wire of a first electric wire at a processing position of a welding machine; arranging a second electric wire at the processing position so as to align an end position of a conductor core wire of the second electric wire with an end position of the conductor core wire of the first electric wire; forming a welding process to the conductor core wire of the first electric wire and the conductor core wire of the second electric wire by the welding machine to form a preliminary welding portion; forming the core wire welding portion by repeating processes for all of the plurality of electric wires; and controlling a magnitude of an energy used in the welding process based on characteristics of conductor core wires to be welded by the welding machine.

According to the present disclosure, it is possible to provide a manufacturing method of an electric wire bundle capable of forming a core wire welding portion while reducing or preventing a positional deviation of an electric wire, and a manufacturing apparatus of the electric wire bundle.

The present disclosure is briefly described as above. Details of the present disclosure are further clarified by reading a mode (hereinafter referred to as “embodiment”) for implementing the present disclosure described below with reference to attached drawings.

### BRIEF DESCRIPTION OF DRAWINGS

Exemplary embodiments of the present disclosure will be described in detail based on the following figures, wherein:

FIG. 1 is a perspective view illustrating an outline of a manufacturing apparatus of an electric wire bundle according to an embodiment of the present disclosure;

FIG. 2 is a schematic view of a welding machine illustrated in FIG. 1;

FIGS. 3A to 3D are diagrams illustrating a procedure when a welding process is performed by the welding machine;

FIG. 4 is a graph showing a relationship between energy (current value in the embodiment) applied during the welding process and thicknesses, and a number of strands included in conductor core wires;

FIG. 5 is a perspective view illustrating a state of welding a plurality of conductor core wires on an end of an electric wire bundle and a terminal;

FIG. 6A is a side view illustrating the state of welding the plurality of conductor core wires on the end of the electric wire bundle and the terminal. FIG. 6B is a front view illustrating the state of welding the plurality of conductor core wires and the terminal by the welding machine; and

FIG. 7A is a top view of the electric wire bundle having a core wire welding portion manufactured by the manufacturing apparatus of the electric wire bundle according to the embodiment of the present disclosure. FIG. 7B is a perspective view illustrating a state of manufacturing the electric wire bundle illustrated in FIG. 7A on a manufacturing line.

### DETAILED DESCRIPTION

### Embodiment

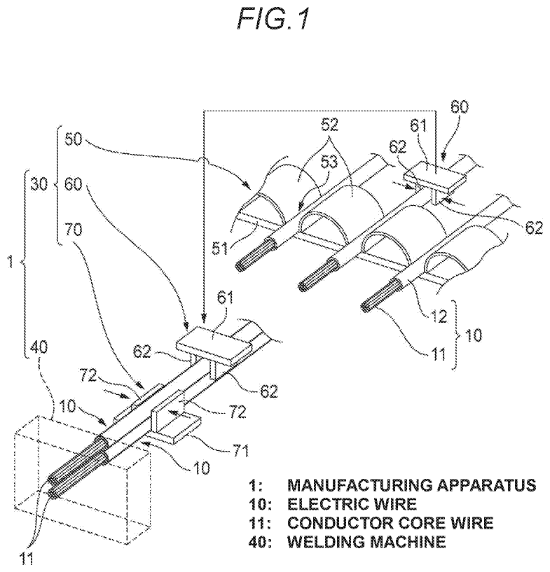

Hereinafter, a manufacturing apparatus 1 of an electric wire bundle according to an embodiment of the present disclosure and a manufacturing method of the electric wire bundle using the manufacturing apparatus 1 are described with reference to FIGS. 1 to 7.

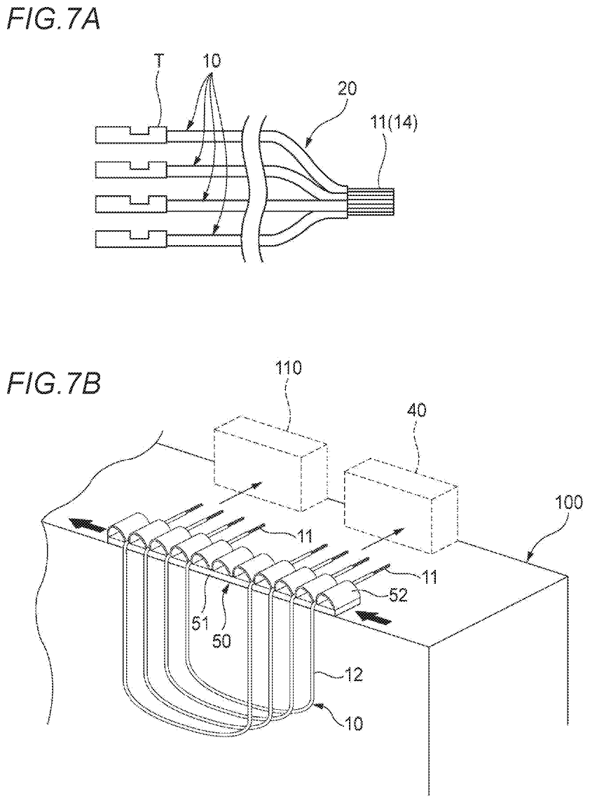

First, FIG. 7A illustrates an example of an electric wire bundle 20 in which a plurality of electric wires 10 manufactured by the manufacturing apparatus 1 in the present example are bundled. The manufacturing apparatus 1 is capable of manufacturing the electric wire bundle 20 having a core wire welding portion 14 in which a plurality of conductor core wires 11 exposed at one end portion of the plurality of electric wires 10 as illustrated in FIG. 7A are welded to each other. In the electric wire bundle 20 illustrated in FIG. 7A, a terminal T is welded to another end portion for each of the plurality of electric wires 10.

Hereinafter, a configuration of the manufacturing apparatus 1 is described with reference to FIGS. 1 to 3. As illustrated in FIG. 1, the manufacturing apparatus 1 includes an arrangement mechanism 30 and a welding machine 40. The arrangement mechanism 30 is configured to arrange the plurality of electric wires 10 to the welding machine 40 so as to perform a process of welding the conductor core wires 11 at the one end portion of the plurality of electric wires 10 to each other by the welding machine 40 (hereinafter referred to as a “welding process”). As described later, the arrangement mechanism 30 is automated by various machines or the like.

The arrangement mechanism 30 includes a holding jig 50, a gripping unit 60, and a holding unit 70. The holding jig 50 is configured to hold the plurality of electric wires 10 before the welding process, and includes a flat holding plate 51 and a plurality of elastic members 52 provided on the holding plate 51. The plurality of elastic members 52 are fixedly arranged on an upper surface in a vicinity of a linear edge portion on one side of the holding plate 51 so as to be aligned in a line along the linear edge portion at predetermined intervals.

In the example illustrated in FIG. 1, each elastic member 52 is formed of a rubber plate that is fixed in a state of being bent so as to protrude in a semi-cylindrical shape from the upper surface of the holding plate 51. Recessed portion 53 that is configured to hold the electric wires 10 is formed between the adjacent elastic members 52 so as to be aligned in a line at predetermined intervals.

In the example illustrated in FIG. 1, the electric wire 10 includes a conductor core wire 11 and an insulation coating 12 covering the conductor core wire 11. The conductor core wire 11 includes a plurality of strands. At the one end portion of the electric wire 10, the insulation coating 12 is removed so that the conductor core wire 11 is exposed. The insulation coating 12 in a vicinity of the plurality of exposed conductor core wires 11 is housed and held in the plurality of recessed portions 53 in a state where end positions of the plurality of electric wires 10 before the welding process are aligned. As a result, as illustrated in FIG. 1, the plurality of electric wires 10 are held on the holding plate 51 so as to be aligned in a line at predetermined intervals in a state where the plurality of electric wires 10 are parallel with one another and the end positions are aligned. As described above, a step of holding the plurality of electric wires 10 before the welding process in the plurality of recessed portion 53 in the state where the end positions are aligned is automatically performed by using the holding jig 50. Thicknesses of the conductor core wires 11 of the plurality of electric wires 10 held by the holding jig 50 may be the same or different.

The gripping unit 60 grips the electric wire 10 held by the holding jig 50 and transports the electric wire 10 to the holding unit 70. The gripping unit 60 includes a flat plate-shaped base plate 61, and a pair of gripping plates 62 that protrude downward so as to face each other on a lower surface side of the base plate 61 and are supported such that an interval between the pair of gripping plates 62 can be adjusted.

The interval between the pair of gripping plates 62 can be automatically adjusted by a driving mechanism being not illustrated. Further, the base plate 61 (and thus the entire gripping unit 60) can be automatically moved to any position over a predetermined range in a state of being maintained in a direction which the pair of gripping plates 62 protrudes downward by a transportation mechanism being not illustrated. Therefore, as illustrated in FIG. 1, the gripping unit 60 is capable of clamping (gripping) the electric wire 10 held by the holding jig 50 with the pair of holding plates 62, and transporting the gripped electric wire 10 to the holding unit 70.

The holding unit 70 holds the electric wire 10 in an appropriate direction and an appropriate attitude with respect to the welding machine 40. The holding unit 70 includes a flat plate-shaped base plate 71, and a pair of holding plates 72 that protrude upward so as to face each other on an upper surface side of the base plate 71 and are supported such that an interval between the pair of holding plates 72 can be adjusted.

The base plate 71 is fixed at a predetermined position with respect to the welding machine 40. The interval between the pair of holding plates 72 can be automatically adjusted by a driving mechanism being not illustrated. Therefore, as illustrated in FIG. 1, the holding unit 70 is capable of clamping (holding) the electric wire 10 transported from the gripping unit 60 by the pair of holding plates 72, and holding the held electric wire 10 in an appropriate direction and an appropriate attitude with respect to the welding machine 40.

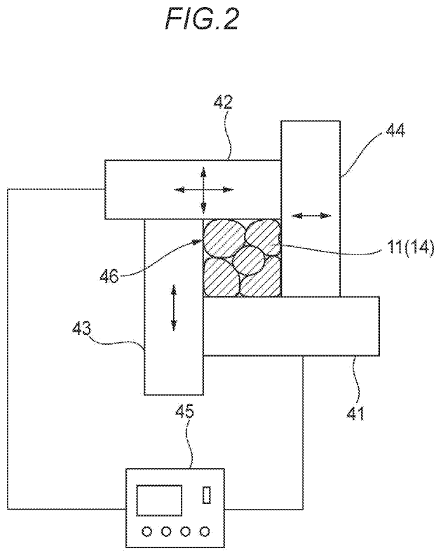

The welding machine 40 performs the welding process on the exposed conductor core wires 11 of the plurality of electric wires 10 held by the gripping unit 60 and the holding unit 70 so as to form the core wire welding portion 14 (see FIG. 7A). Specifically, as illustrated in FIG. 2, the welding machine 40 includes a pair of flat plate-shaped electrodes 41, 42 facing each other in an upper-lower direction, a pair of flat plate-shaped positioning blocks 43, 44 facing each other in a left-right direction, and a control device 45 that is configured to control energy for welding (applied current value) to be applied between the pair of electrodes 41, 42.

A prismatic welding space 46 is defined by the pair of electrodes 41, 42 and the pair of positioning blocks 43, 44. The exposed conductor core wires 11 of the plurality of electric wires 10 held by the gripping unit 60 and the holding unit 70 are arranged inside the welding space 46.

The electrode 41 is fixed to the welding machine 40. The electrode 42, the positioning block 43, and the positioning block 44 are movable in parallel in directions of arrows illustrated in FIG. 2 with respect to the electrode 41. Therefore, the welding machine 40 is capable of performing resistance welding processing on the plurality of conductor core wires 11 by applying the energy (current) between the pair of electrodes 41, 42 in a state where the plurality of conductor core wires 11 arranged in the welding space 46 are compressed. As a result, the core wire welding portion 14 in which the plurality of conductor core wires 11 are welded is formed.

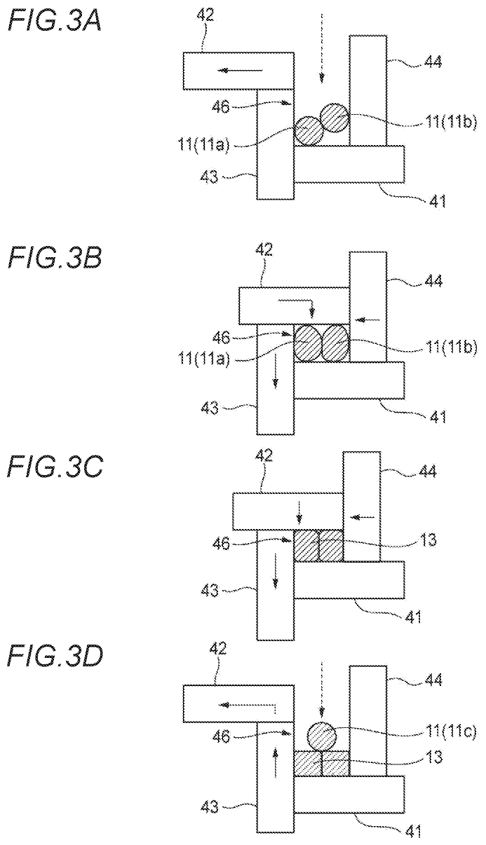

Next, a specific manufacturing method of the electric wire bundle using the manufacturing apparatus 1 is described. First, as illustrated in FIG. 1, as preparation, the plurality of electric wires 10, in which the conductor core wires 11 are exposed at the one end portion, are held, respectively, in the plurality of recessed portions 53 of the holding jig 50 so as to be aligned in a line at the predetermined intervals in the state where the plurality of electric wires 10 are parallel with one another and the end positions are aligned. As described above, the step of holding, respectively, the plurality of electric wires 10 in the plurality of recessed portion 53 is automatically performed by using the holding jig 50. Further, as illustrated in FIG. 3A, in the welding machine 40, the electrode 42 is moved leftward (in a direction away from the positioning block 44) so as to open an upper side of the welding space 46.

In this state, the first electric wire 10 among the plurality of electric wires 10 held by the holding jig 50 is gripped by the gripping unit 60, and is transported to the holding unit 70. Specifically, a portion, which is slightly away from a part of the insulation coating 12 of the first electric wire 10 held by the recessed portion 53 on a side opposite to the end of the electric wire 10, is clamped (gripped) by the pair of gripping plates 62 by adjusting the interval between the pair of gripping plates 62 in a direction which the interval decreases, so that the gripped first electric wire 10 is transported to the holding unit 70 by moving the gripping unit 60 in this state. With the first electric wire 10 being transported to the holding unit 70, as illustrated in FIG. 1, the holding unit 60 is positioned slightly away from the holding unit 70 on a side opposite to the welding machine 40. The first electric wire 10 extends to the welding machine 40 via a space between the pair of holding plates 72 of the holding unit 70.

Next, the first electric wire 10 is held by the holding unit 70 while maintaining a state where the first electric wire 10 is gripped by the gripping unit 60. Specifically, as illustrated in FIG. 1, the insulation coating 12 in a vicinity of the exposed conductor core wire 11 of the first electric wire 10 is held by the pair of holding plates 72 by adjusting the interval between the pair of holding plates 72 in the direction which the interval decreases. Thereafter, the gripping of the first electric wire 10 by the gripping unit 60 is released by adjusting the interval between the pair of gripping plates 62 of the gripping unit 60 in a direction which the interval increases, so that the first electric wire 10 is held only by the holding unit 70. As described above, in the state where the first electric wire 10 is held by the holding unit 70, as illustrated in FIG. 3A, the conductor core wire 11 (11a) of the first electric wire 10 is arranged in the welding space 46.

Then, the second electric wire 10 among the plurality of electric wires 10 held by the holding jig 50 is gripped by the gripping unit 60 and is transported to the holding unit 70 in the similar manner as the first electric wire 10, and is arranged adjacent to the first electric wire 10 so as to align the end position of the second electric wire 10 with the end position of the first electric wire 10 held by the holding unit 70 and to be parallel to each other. As a method of aligning the end positions, a method such as abutting on a predetermined flat plate or transporting the electric wires 10 in accordance with an operation parameter set in advance for alignment with a control device being not illustrated of the gripping unit 60 or the like is adopted.

Unlike the first electric wire 10, the second electric wire 10 is not held by the holding unit 70. That is, the first electric wire 10 is held only by the holding unit 70 and the second electric wire 10 is gripped only by the gripping unit 60, so that the first and second electric wires 10 are held adjacent to each other in a state where the end positions are aligned. As a result, as illustrated in FIG. 3A, in addition to the conductor core wire 11a of the first electric wire 10, the conductor core wire 11 (11b) of the second electric wire 10 is arranged so as to be adjacent to the conductor core wire 11a in the welding space 46.

Next, as illustrated in FIG. 3B, the electrode 42 is moved rightward (direction in which the electrode 42 approaches the positioning block 44) to close the welding space 46, and the electrode 42, the positioning block 43, and the positioning block 44 are moved in directions of respective arrows illustrated in FIG. 3B to narrow the welding space 46, so that the positional relationship between the conductor core wire 11a of the first electric wire 10 and the conductor core wire 11b of the second electric wire 10 is adjusted to a desired aspect.

Next, as illustrated in FIG. 3C, the electrode 42, the positioning block 43, and the positioning block 44 are moved in directions of respective arrows illustrated in FIG. 3C to further narrow the welding space 46, so that the conductor core wire 11a of the first electric wire 10 and the conductor core wire 11b of the second electric wire 10 are compressed, and energy (current) of a predetermined magnitude is applied between the pair of electrodes 41, 42 in the state where the conductor core wires are compressed. As a result, a resistance welding process is performed on the conductor core wires 11a, 11b to form a preliminary welding portion 13 in which the conductor core wires 11a, 11b are welded. Thereafter, the gripping of the second electric wire 10 by the gripping unit 60 is released. The first and second electric wires 10 are inseparably connected to each other by the preliminary welding portion 13, so that a positional deviation of the second electric wire 10 in an axial direction with respect to the first electric wire 10 is prevented even when the gripping of the second electric wire 10 by the gripping unit 60 is released.

Next, as illustrated in FIG. 3D, the electrode 42 is moved leftward so as to open the upper side of the welding space 46. In this state, the third electric wire 10 among the plurality of electric wires 10 held by the holding jig 50 is gripped by the gripping unit 60 and is transported to the holding unit 70 in the similar manner as the second electric wire 10, and is arranged adjacent to the first and second electric wires 10 that the preliminary welding portion 13 is formed so as to align the end position of the third electric wire 10 with the end position of the first and second electric wires 10 and to be parallel to one another.

The third electric wire 10 is not held by the holding unit 70 in the similar manner as the second electric wire 10. That is, the first electric wire 10 is held by the holding unit 70, the second electric wire 10 is inseparably connected to the first electric wire 10 via the preliminary welding portion 13, and the third electric wire 10 is gripped only by the gripping unit 60, so that the first to third electric wires 10 are held adjacent to each other in the state where the end positions are aligned. As a result, as illustrated in FIG. 3D, in addition to the preliminary welding portion 13, the conductor core wire 11 (11c) of the third electric wire 10 is arranged so as to be adjacent to the preliminary welding portion 13 in the welding space 46.

Next, the operations illustrated in FIG. 3B to FIG. 3C described above are sequentially performed to weld the conductor core wire 11c of the third electric wire 10 to the preliminary welding portion 13 formed of the conductor core wires 11a, 11b, so as to form a new preliminary welding portion 13 in which the conductor core wires 11a to 11c are integrated. Thereafter, the operation illustrated in FIG. 3D is performed again, so that the fourth electric wire 10 among the plurality of electric wires 10 held by the holding jig 50 is arranged adjacent to the first to third electric wires 10 that the preliminary welding portion 13 is formed so as to align the end position of the fourth electric wire 10 with the end position of the first to third electric wires 10 and to be parallel to one another.

The core wire welding portion 14 (see FIG. 7A), in which all the conductor core wires 11 of the plurality of electric wires 10 are integrated, is formed by repeating the operations illustrated in FIGS. 3B to 3D for all of the plurality of electric wires 10 held by the holding jig 50.

As described above, after welding the conductor core wires 11 of the first and second electric wires 10 among the plurality of electric wires 10 to form the preliminary welding portion 13, other electric wires 10 are repeatedly welded to the preliminary welding portion 13 one by one to form the core wire welding portion 14. Therefore, the end positions of the conductor core wires 11 can be aligned each time the conductor core wires 11 are welded one by one, so that the core wire welding portion 14 can be formed while reducing or preventing the positional deviation of the electric wires 10 in the axial direction.

As described above, in forming the core wire welding portion 14 in which the conductor core wires 11 at one end portion of the plurality of electric wires 10 are welded, the welding process is performed (a number of the plurality of electric wires 10-1) times. Here, it is preferable that the magnitude of the energy (current) applied between the pair of electrodes 41, 42 in each welding process is adjusted based on characteristics (for example, a thickness, a number and a material of the plurality of strands included in the conductor core wire 11) of the conductor core wire 11 to be subjected to the welding process.

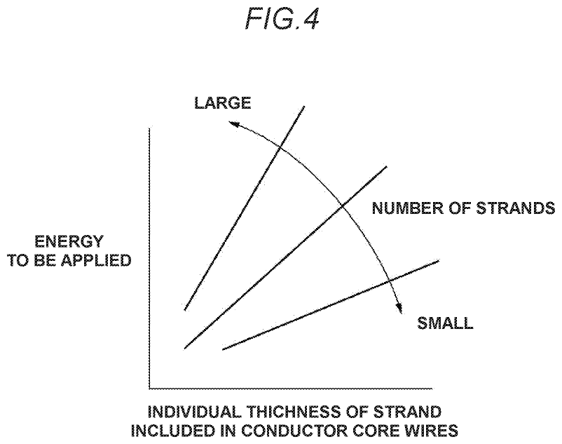

Specifically, for example, as shown in FIG. 4, it is preferable to adjust the magnitude of the applied energy (current) to a larger value as the individual thickness of the plurality of strands provided in the conductor core wire 11 is larger and the number of the plurality of strands is larger. As a result, it is possible to more reliably ensure the welding of the conductor core wire 11 by performing the welding process with energy (current) in consideration of the thickness and the number of the strands included in the conductor core wire 11.

Further, the magnitude of the energy (current) in the final welding process (that is, the Nth welding process among the first, the second, the third, and the Nth welding processes, and the welding process when the conductor core wire 11 of the last one electric wire among the plurality of electric wires 10 is welded to the preliminary welding portion 13 to form the core wire welding portion 14) among the plurality of welding processes may be larger than the magnitude of the energy (current) in the welding process other than the final welding process. As a result, in the final welding process, the energy larger than that used in the previous welding process is used such that the core wire welding portion 14 as a final product has a size and a shape and the like as designed. As a result, the electric wire bundle excellent in quality such as dimensional accuracy of the core wire welding portion 14 can be obtained.

Alternatively, the magnitude of the energy (current) may be gradually increased as the number of times of performing the welding process increases. The conductor core wire 11 welded at a stage of the welding process close to the first welding process among the plurality of welding processes is also subjected to the subsequent multiple welding processes (that is, total energy applied to the conductor core wire 11 at the stage of the welding process close to the first welding process increases). Here, a total energy variation based on which stage of the plurality of welding processes is performed can be reduced as compared with a case where the magnitude of the energy is uniform regardless of the number of times of the welding processes by gradually increasing the magnitude of energy as the number of times of performing the welding process increases. As a result, it is possible to ensure reliable welding as a whole of the core wire welding portion 14, and to further reduce or prevent occurrence of breakage and the like in the conductor core wire 11 due to excessive total energy of some of the conductor core wires 11.

As mentioned above, according to the manufacturing apparatus 1 of the electric wire bundle 20 and the manufacturing method of the electric wire bundle 20 using the manufacturing apparatus 1 according to the embodiment of the present disclosure, after welding the conductor core wires 11 of the two electric wires 10 (the first electric wire 10 and the second electric wire 10) among the plurality of electric wires 10 to form the preliminary welding portion 13, the other electric wires 10 are repeatedly welded to the preliminary welding portion 13 one by one to form the core wire welding portion 14. In this manufacturing method, the end positions of the conductor core wires 11 can be aligned each time the conductor core wires 11 are welded one by one, so that the positional deviation as the related manufacturing method described above can be reduced or prevented. Therefore, the core wire welding portion 14 can be formed while reducing or preventing the positional deviation of the electric wires 10.

Further, according to this manufacturing method, all the steps are automated by a machine. That is, it is not necessary for an operator to process the positional deviation of the electric wire (positional deviation of the end of the conductor core wire) as in the related manufacturing method, so that all the steps can be mechanized and automated. Therefore, the electric wire bundle 20 can be produced more efficiently than in a case of manual manufacture by an operator.

Further, a welding state can be managed for each individual conductor core line by controlling the magnitude of the energy for welding (for example, the applied current value) based on the characteristics (for example, the thickness and the number of the strands, and the material of the strands) of the conductor core wire to be welded. As a result, as compared with a case where a large number of conductor core wires are welded at one time as in the related manufacturing method, it is possible to ensure reliable welding as a whole of the core wire welding portion.

### Other Embodiments

The present disclosure is not limited to the above embodiment, and various modifications can be adopted within the scope of the present disclosure. For example, the present disclosure is not limited to the above-described embodiment, and can be appropriately modified, improved, and the like. In addition, a material, a shape, a size, a number, an arrangement position, and the like of each constituent element in the above-described embodiment are selectable as long as the present disclosure can be achieved, and the present disclosure is not limited thereto.

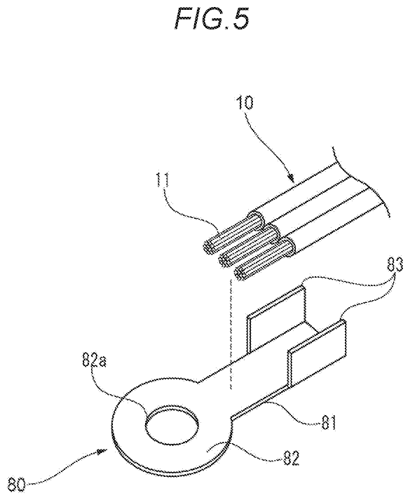

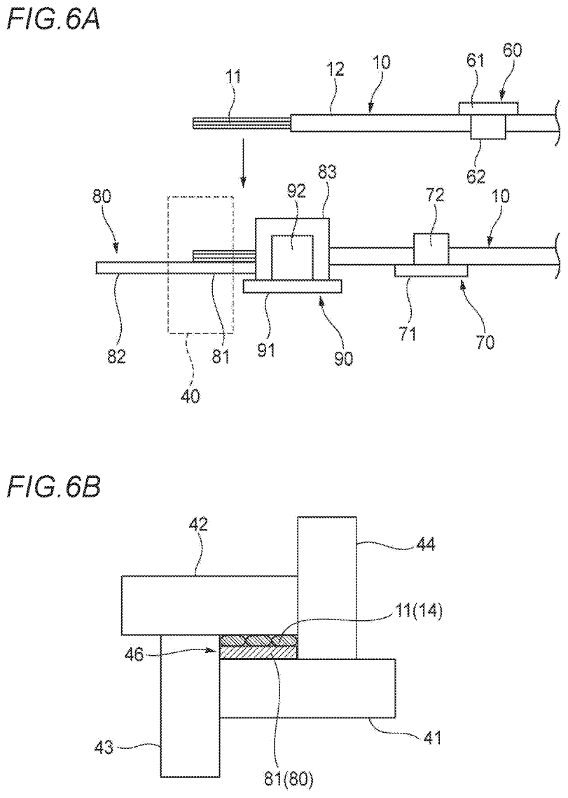

For example, in the above embodiment, as illustrated in FIG. 7A, only the plurality of conductor core wires 11 at one end portion of the plurality of electric wires 10 are welded to form the core wire welding portion 14. In contrast, as illustrated in FIGS. 5 and 6, the plurality of conductor core wires 11 at the one end portion of the plurality of electric wires 10 may be welded to a terminal 80 to form the core wire welding portion 14 welded to the terminal 80.

In an example illustrated in FIGS. 5 and 6, the terminal 80 includes a main body portion 81, a connection portion 82 that is integrally formed on one end side of the main body portion 81 and is formed with a bolt hole 82a for connection with a mating member, and a pair of barrel portions 83 that are integrally erected on another end side of the main body portion 81. As illustrated in FIG. 6, a terminal holding unit 90 is newly provided between the welding machine 40 and the holding unit 70.

The terminal holding unit 90 includes a base plate 91 and a pair of holding plates 92 respectively corresponding to the base plate 71 and the pair of holding plates 72 of the holding unit 70. The pair of barrel portions 83 of the terminal 80 are held by the terminal holding unit 90. In the state where the pair of barrel portions 83 are held by the terminal holding unit 90, as illustrated in FIG. 6, the main body portion 81 (portion at which the pair of barrel portions 83 are not formed) of the terminal 80 is placed on a bottom surface (that is, an upper surface of the electrode 41) of the welding space 46 of the welding machine 40.

As described above, in the state where the main body portion 81 of the terminal 80 is placed on the bottom surface of the welding space 46 of the welding machine 40, as in the above embodiment, the core wire welding portion 14 welded to the terminal 80 can be obtained by welding the conductor core wires 11 of the electric wires 10 one by one to an upper surface of the main body portion 81 of the terminal 80.

Further, in manufacturing the electric wire bundle 20 illustrated in FIG. 7A in which the core wire welding portion 14 is formed at the one end portion of the plurality of electric wires 10 and the terminal T is welded to the other end portion for each of the plurality of electric wires 10, a manufacturing line as illustrated in FIG. 7B may be used. In this example, the terminal T is a general crimp terminal that is different from the terminal 80 illustrated in FIG. 5.

In the example illustrated in FIG. 7B, the holding jig 50 that is configured to hold the plurality of electric wires 10 is moved at a predetermined speed in a direction (traveling direction) along a front surface of the work table 100 on a front side (near side) of a work table 100 of the manufacturing line (see thick arrows). On a rear side (back side) of the work table 100, the welding machine 40 and a terminal crimping machine 110 are fixedly arranged such that the welding machine 40 and the terminal crimping machine 110 are aligned in a line at predetermined intervals in the traveling direction, and that the terminal crimping machine 110 is positioned on a downstream side in the traveling direction with respect to the welding machine 40.

In a region on a upstream side in the traveling direction of the holding jig 50, the one end portion of the plurality of electric wires 10 is held in a state where the plurality of exposed conductor core wires 11 are parallel to each other and face the back side of the work table 100. In a region on the downstream side in the traveling direction of the holding jig 50, the other end portion of the plurality of electric wires 10 is held in the state where the plurality of exposed conductor core wires 11 are parallel to each other and face the back side of the work table 100.

It is possible to efficiently perform the formation of the core wire welding portion 14 at the one end portion of the plurality of electric wires 10 and the welding of the terminal T to the other end portion for each of the plurality of electric wires 10 by using the manufacturing line configured as described above. Further, all the steps can be automated by a machine. However, some of the steps or all the steps may be performed manually by an operator.

Further, in the above embodiment, the resistance welding process is adopted as the welding process (see FIG. 2 and the like). In contrast, an ultrasonic welding process may be adopted as the welding process. In this case, for example, in the welding machine 40 illustrated in FIG. 2, the electrode 41 may be replaced with a horn, and the electrode 42 may be replaced with an anvil, so that ultrasonic vibration can be applied to the horn. In particular, when the conductor core wire 11 of the electric wire 10 is made of aluminum, it is difficult for the current to flow through the conductor core wire 11 due to an oxide film that is likely to be formed on a surface of the conductor core wire 11, so that it is preferable to adopt the ultrasonic welding process instead of the resistance welding process as the welding process. In a case of the ultrasonic welding process, the magnitude (see FIG. 4) of the energy to be applied can be controlled, for example, by adjusting a pressure applied to the conductor core wire 11 and a work amount (processing time and amplitude).

### REFERENCE SIGNS LIST

1 manufacturing apparatus
10 electric wire
11 conductor core wire
13 preliminary welding portion
14 core wire welding portion
20 electric wire bundle
30 arrangement mechanism
40 welding machine

What is claimed is:

1. A manufacturing method of an electric wire bundle including a core wire welding portion in which a plurality of conductor core wires exposed from ends of a plurality of electric wires are welded to each other, the manufacturing method comprising:
arranging the conductor core wire of a first electric wire among the plurality of electric wires from which the conductor core wire is exposed at a processing position of a welding machine;
arranging a second electric wire among the plurality of electric wires at the processing position so as to align an end position of the conductor core wire of the second electric wire with an end position of the conductor core wire of the first electric wire;
performing a welding process to the conductor core wire of the first electric wire and the conductor core wire of the second electric wire by the welding machine to form a preliminary welding portion;
forming the core wire welding portion by repeating processes for all of the plurality of electric wires, the processes including:
arranging a third electric wire other than the first electric wire and the second electric wire of the plurality of electric wires at the processing position so as to align an end position of the conductor core wire of the third electric wire with an end position of the preliminary welding portion, and
performing the welding process to the conductor core wire of the third electric wire and the preliminary welding portion by the welding machine, and
controlling a magnitude of an energy used in the welding process based on characteristics of conductor core wires to be welded by the welding machine.

2. The manufacturing method of an electric wire bundle according to claim 1, the manufacturing method further comprises:
performing at least one of a first control to increase the energy as a strand included in the conductor core wire to be welded is thicker and a second control to increase the energy as a number of the strands increases by the welding machine.

3. The manufacturing method of an electric wire bundle according to claim 1, the manufacturing method further comprises:
performing a third control such that the magnitude of the energy in a final welding process is larger than the magnitude of the energy in the welding process other than the final welding process by the welding machine,
wherein, in the final welding process, the conductor core wire of a last electric wire among the plurality of electric wires is welded to the preliminary welding portion to form the core wire welding portion.

4. The manufacturing method of an electric wire bundle according to claim 1, the manufacturing method further comprises:
performing a fourth control to increase the magnitude of the energy as the number of times of the welding process increases, when performing the welding process of the predetermined number of times until obtaining the core wire welding portion by the welding machine.

5. The manufacturing method of an electric wire bundle according to claim 1,
wherein an ultrasonic welding process or a resistance welding process is used as the welding process.

6. A manufacturing apparatus of an electric wire bundle including a core wire welding portion in which a plurality of conductor core wires exposed from ends of a plurality of electric wires are welded to each other, the manufacturing apparatus comprising:
an arrangement mechanism that is configured to arrange the conductor core wire of a first electric wire among the plurality of electric wires from which the conductor core wire is exposed at a processing position where a welding process is performed, and to arrange a second electric wire among the plurality of electric wires at the processing position so as to align an end position of the conductor core wire of the second electric wire with an end position of the conductor core wire of the first electric wire; and
a welding machine that is configured to perform the welding process to the conductor core wire of the first electric wire and the conductor core wire of the second electric wire to form a preliminary welding portion,
wherein the core wire welding portion is formed by repeating processes for all of the plurality of electric wires, the processes being configured to:
arrange a third electric wire other than the first electric wire and the second electric wire of the plurality of electric wires at the processing position by the arrangement mechanism so as to align an end position of the conductor core wire of the third electric wire with an end position of the preliminary welding portion, and
perform the welding process to the conductor core wire of the third electric wire and the preliminary welding portion by the welding machine, and
wherein the welding machine is configured to control a magnitude of an energy used in the welding process based on characteristics of the conductor core wires to be welded.
